(19) United States
(12) Patent Application Publication
(10) Pub. No.: US 2008/0151053 A1
(43) Pub. Date: Jun. 26, 2008

(54) Operation Support Device

(75) Inventors: Hirofumi Ishii, Oosaka-fu (JP); Kazufumi Mizusawa, Kanagawa-ken (JP); Tuyoshi Okada, Kanagawa-ken (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 10/597,922

(22) PCT Filed: Feb. 16, 2005
(86) PCT No.: PCT/JP2005/002287

§ 371 Date: Aug. 11, 2006

(30) Foreign Application Priority Data
Feb. 16, 2004 (JP) 2004-038640

(51) Int. Cl. H04N 7/18; H04N 5/225

(52) U.S. Cl. 348/148; 348/208.6; 348/E07.085

(57) ABSTRACT

It is an object to provide an operation support device which can produce an image to be displayed on a screen at a relatively high quality without being affected by the swing of the rod-like retaining means. The operation support device includes a rod-like retaining unit 12 projected from an automotive vehicle 11, a camera unit 13 mounted on the rod-like retaining unit 12, the camera unit 13 being adapted to take an image of an object around the automotive vehicle 11, and a swing compensation image processing unit 14 for processing the image taken by the camera unit 13 on the basis of the estimated swing of the camera unit 13 to a road surface (a special distance plane), the processed image beings in parallel relationship with the taken image.

### TECHNICAL FIELD OF THE INVENTION

This invention relates to an operation support device, and more particularly to an operation support device for taking images of one or more objects located around an automotive vehicle, and having a displaying unit inside the automotive vehicle display the images on a screen.

### DESCRIPTION OF THE RELATED ART

Conventionally, there has been used mirrors such as for example fender mirrors, back mirrors and the like to help a driver easily monitor objects positioned at dead angles formed by the backward portion, the both sides of the backward portion, and the both sides of the forward portion of the automotive vehicle. In recent years, one or more cameras are considered to be used together with these mirrors for the same purpose. These cameras are adapted to take an image of objects located around the automotive vehicle to be displayed on a displaying unit inside the automotive vehicle to assist the driver in the driving operation of the automotive vehicle.

One of the technologies of this kind is disclosed for example by a Patent Publication No. 1 in which a camera used for the automotive vehicle is adapted to monitor the backward portion of the automotive vehicle to assist the driver in the driving operation of the automotive vehicle moving backwardly. The cameras of this type are considered to be mounted on one or more portions of the automotive vehicle depending upon the type of the camera.

Another technology of this kind is disclosed by a Patent Publication No. 2 as comprising a rod-like member having at its top end a lens and an image taking element which are adapted to take an image of objects surrounding the automotive vehicle for the driver to easily monitor the surrounding objects of the automotive vehicle with his or her viewing points relatively high in degrees of freedom, thereby securing a still further enhanced safety to the driver when driving the automotive vehicle.

The technology of the Patent Publication No. 2 encounters such a problem that the lens and the image taking element mounted on the top end of the rod-like member causes the rod-like member to be swung freely, thereby generating an image vibrated on the displaying unit.

As one of the technologies to overcome the foregoing vibrated image on the displaying unit, there is known by a Patent Publication No. 3 which does not necessarily teach how the known technology is applied to the automotive vehicle. The technology disclosed in the Patent Publication No. 3 comprises a monitoring camera mounted on an extendible and contractible rod member, a position setting apparatus for setting a monitoring position for the monitoring camera to take an image of the objects surrounding the automotive vehicle, and a standard image setting apparatus for setting a standard image serving as a standard target to be monitored on the displaying unit. The monitoring camera disclosed in the Patent Publication No. 3 comprises a frame memory unit for memorizing the monitored image of the standard target taken by the monitoring camera to be inputted through the lens, a detection area designating unit for designating a detection area among areas of the monitoring image extending on the image displaying means, a correlation control apparatus for updating the content of the memory unit when determining that the correlation between the monitored image and the standard image exists in accordance with the image on the detection area on the image displaying means, to ensure that the monitored image is prevented from being vibrated to appear on the image displaying means to enhance the effectiveness of the monitoring operation by the technology disclosed in the patent publication No. 3.
Patent Publication No. 1: Tokkaihei No. 2-36417 Publication
Patent Publication No. 2: Tokkai No. 2003-63310 Publication
Patent Publication No. 3: Tokkaihei No. 09-312836 Publication

### DISCLOSURE OF THE INVENTION

### Problems to be Solved by the Invention

The technology of the Patent Publication No. 3, however, encounters such a problem that the rod member causes the targeted objects such as the road surface, other neighboring automotive vehicles and other obstacles surrounding the automotive vehicle to be moved within the monitoring image displayed on the display unit in accompaniment with the movement of the automotive vehicle driven by the driver, thereby making it impossible for the monitoring image to be prevented from being vibrated on the displaying unit.

For this end, there has so far been proposed a moving camera and others which are devised to be operated with a swing compensation in such a way that the swing compensation for a wing 4 with the view point position being kept constant and with only the view line being rotated as seen from FIG. 22 is carried out by an optical system forming part of the image taking apparatus 1 and other image processing methods of the image taking apparatus 1. The swing compensation 1 for the swing 4 is effective, resulting from the same swing of the targeted object 2 as that of the targeted object 3 on the displaying unit though the targeted objects 2 and 3 differ from each other in distance from the image taking apparatus 1. The rod member is, however, swung with its view position being swung in a direction 5 shown by an arrow in FIG. 23, resulting in the fact that the targeted objects 6 and 7 different in distance from the image taking apparatus 1 are displayed on the displaying unit with the effect of the targeted objects 6 and 7, i.e., the swing amounts of the targeted objects 6 and 7 being different in distance from the image taking apparatus 1. This means that the conventional compensation method is generally not effective to the above case.

The present invention is made for the purpose of solving these problems, and to provide an operation support device which can produce an image to be displayed on a screen at a relatively high quality without being affected by the swing of the rod-like retaining means.

### Means for Solving the Problems

The operation support device according to the present invention comprises: retaining means in the form of a rod and projected from an automotive vehicle; image taking means mounted on and retained by said retaining means to take images of objects around said automotive vehicle; and swing compensation image processing means for processing said images taken by said image taking means with a swing compensation amount corresponding to a swing on a special distance plane distant from said image taking means.

The operation support device thus constructed can advantageously produce an excellent quality of image, resulting from the fact that the swings of the images of the objects to be monitored on the special surface distant from the image taking means, for example, the targeted objects on a road surface is lessened to a level as small as possible even if the rotational and positional swings of the image taking means are caused by the swings of the rod-like retaining means.

In the operation support device according to the present invention, the swing compensation image processing means is adapted to detect a rotational swing and a positional swing of the image taking means mounted on the rod-like retaining means by chasing two or more particular points defined on the automotive vehicle 11, and to compensate the image by canceling the effect of the rotational and positional swings of the image taking means on the special distance plane.

The swing compensating image processing means forming part of the operation support device according to the present invention thus constructed can chase a plurality of particular points set on the automotive vehicle while detecting the rotational and positional swings of the image taking means mounted on the retaining means to ensure that the effects of the images of the targeted objects on the special plane distant from the image taking means caused by the rotational and positional swings of the image taking means are cancelled and compensated with each other. It is therefore to be understood that the swings of the images of the objects to be taken on the special surface distant from the image taking means, for example, the targeted objects on a road surface can be lessened to a level as small as possible, thereby making it possible to produce an excellent quality of image on the displaying unit.

The operation support device according to the present invention further comprises detecting means for detecting a rotational swing and a positional swing of the image taking means. The swing compensation image processing means is adapted to compensate the image by canceling the effect of the rotational and positional swings of the image taking means on the special distance plane.

The operation support device according to the present invention thus constructed can produce an excellent quality of image on the displaying unit by directly detecting the rotational and positional swings of the image taking unit to cancel and compensate the swings of the images of the targeted objects positioned on a special plane, for example a road surface, spaced apart from the image taking means, thereby making the swings lessened to a level as small as possible.

In the operation support device according to the present invention, the swing compensation image processing means is adapted to perform a projective transformation of the taken image to an image projected on a special distance plane before performing an inverse projective transformation to an image to be outputted as an image taken with no swing by an imaginary image taking means.

The operation support device according to the present invention thus constructed can produce an excellent quality of image on the displaying unit by having the projected and transformed image transformed into an inversely projected and transformed image on the imaginary image taking means after having the images of the targeted objects on the special plane spaced apart from the image taking means projected and transformed, thereby making it possible to compensate the effect of the positional and rotational swings of the image taking means between the operation of projecting and transforming the images and the operation of inversely projecting and transforming the images.

The operation support device according to the present invention further comprises distance means for detecting a distance between the object and the image taking means. The swing compensation image processing means is adapted to change the special distance plane on the basis of the distance between the object and the image taking means.

The operation support device according to the present invention thus constructed can produce an excellent quality of image on the displaying unit by changing the special plane from the road surface to the height of a bumper forming part of the automotive vehicle when obstacles such as for example the bumper forming part of the other automotive vehicle comes to enter the range of the images to be currently taken by the image taking unit so that the obstacles such as the bumper forming part of the other automotive vehicle which are more important as a target to be monitored than the road surface can be displayed on the image displaying means in a state to easily monitor the image of the bumper on the image displaying means.

In the operation support device according to the present invention, the swing compensation image processing means is adapted to produce images compensated on respective distance planes by canceling the effect of the rotational and positional swings of the image taking means on the distance planes, and to select, as an image to be synthesized, one of the images compensated on the respective distance planes by judging whether or not each of the images compensated on the respective distance planes corresponds to an predictive image which is produced from one or more prior images on the basis of a movement of the automotive vehicle.

The swing compensating image processing means forming part of the operation support device according to the present invention thus constructed can make a decision on whether the compensated image obtained by compensating the positional and rotational swings of the image taking means on a plurality of distance plane spaced apart form the image taking means is in registry with an estimated image estimated from the images obtained in the past from the movements of the automotive vehicle, so that the obstacles and the road surface can partly be displayed on the image displaying means in a state to easily monitor the image even when the obstacles comes to enter the range of the images to be currently taken by the image taking meas.

The operation support device according to the present invention further comprises oscillation means for swinging the rod-like retaining means. The swing compensation image processing means is adapted to detect the special distance plane with the swing of the image taking means under the condition that the rod-like retaining means is being swung by the oscillation means.

The operation support device according to the present invention thus constructed can allow the rod-like retaining means to be oscillated by the oscillation means to cause the image taking means to be positionally swung and to cause the image on the image displaying means to be swung at its swing amount corresponding to the amount of the oscillation of the image taking means to detect the special distance plane from the image taking means from the swing amount of the image on the image displaying means so that the operation support device can detect whether the special distance plane is the road surface or the obstacle.

The operation support device according to the present invention further comprises displaying means for displaying the image taken by the image taking means.

The operation support device thus constructed can help a driver easily monitor a surrounding situation of the automotive vehicle to secure the driver's safety to a much higher level.

### Advantageous Effect of the Invention

From the foregoing description, it will be understood that the operation support device according to the present invention can produce an image to be displayed on a screen at a relatively high quality without being affected by the swing of the rod-like retaining means.

### BRIEF DESCRIPTION OF THE DRAWINGS

FIGS. 1 are schematic views of the first embodiment of an operation support device according to the present invention, (a) showing a schematic front view of an automotive vehicle having a rod portion held in its extended state, (b) showing a schematic side view of the automotive vehicle having a rod portion held in its extended state;

FIGS. 2 are schematic views of the first embodiment of the operation support device according to the present invention, (a) showing a schematic front view of an automotive vehicle having a rod portion held in its contracted state, (b) showing a schematic side view of the automotive vehicle having a rod portion held in its contracted state;

FIG. 3 is a schematic view showing an image taken by the camera forming part of the first embodiment of the operation support device according to the present invention;

FIGS. 4(a) and 4(b) are explanation views for explaining a method of estimating the swings on the road surface by chasing two particular points in the image displayed by image displaying means forming part of the operation support device according to the present invention;

FIGS. 5 are schematic views each showing a camera and a counter weight mounted on the rod portion forming of the first embodiment of the operation support device according to the present invention;

FIGS. 6 are schematic views of the second embodiment of an operation support device according to the present invention, (a) showing a schematic front view of an automotive vehicle having an operation support device, (b) showing a schematic side view of the automotive vehicle having the operation support device;

FIG. 7 is a block diagram of the second embodiment of the operation support device according to the present invention;

FIGS. 8(a) and 8(b) are explanation views for explaining an operation to compensate the swings with the second embodiment of the operation support device according to the present invention;

FIG. 9 is s a block diagram of the second embodiment of the operation support device according to the present invention which is different in construction from the second embodiment of the operation support device shown in FIG. 7;

FIGS. 10(a), 10(b) and 10(c) are explanation views for explaining an operation to compensate the swings with the second embodiment of the operation support device according to the present invention which is different in steps from the second embodiment of the operation support device shown in FIG. 8;

FIGS. 11 are schematic views of the third embodiment of an operation support device according to the present invention, (a) showing a schematic front view of an automotive vehicle having an operation support device, (b) showing a schematic side view of the automotive vehicle having the operation support device;

FIG. 12 is an explanation view for explaining an operation performed by a distance device and a swing compensation image processing unit forming part of the third embodiment of the operation support device according to the present invention;

FIGS. 13 are schematic views showing an image outputted by the third embodiment of the assisting apparatus according to the present invention, (a) showing an outputted image with no obstacles, (b) showing an outputted image with obstacles detected;

FIGS. 14 are schematic views of the fourth embodiment of an operation support device according to the present invention, (a) showing a schematic front view of an automotive vehicle having an operation support device, (b) showing a schematic side view of the automotive vehicle having the operation support device;

FIG. 15 is s a block diagram of the fourth embodiment of the operation support device according to the present invention;

FIGS. 16(a) and 16(b) are explanation views for explaining an operation to compensate the swing with the fourth embodiment of the operation support device according to the present invention, (a) showing a camera for taking an image to be transformed into a projected and transformed image and a projected and transformed range, (b) showing an imaginary camera unit for taking an image to be transformed into an inversely projected and transformed image and an inversely projected and transformed range;

FIGS. 17 are schematic views showing an image outputted by the fourth embodiment of the assisting apparatus according to the present invention, (a) showing an outputted image with no obstacles, (b) showing an outputted image with obstacles detected;

FIG. 18 is s a block diagram of the fourth embodiment of the operation support device according to the present invention which is different in construction from the fourth embodiment of the operation support device shown in FIG. 15;

FIGS. 19 are schematic views of the fifth embodiment of an operation support device according to the present invention, (a) showing a schematic front view of an automotive vehicle having an operation support device, (b) showing a schematic side view of the automotive vehicle having the operation support device;

FIG. 20 is a block diagram of the fifth embodiment of the operation support device according to the present invention;

FIGS. 21 are explanation views for explaining an operation to compensate the swings with the fifth embodiment of the operation support device according to the present invention, (a) showing a positional relationship between a camera oscillated and obstacles, (b) showing a relationship between the oscillation and the time of the camera oscillated;

FIG. 22 is an explanation view for explaining an operation to compensate the swing with a movie camera and the like; and

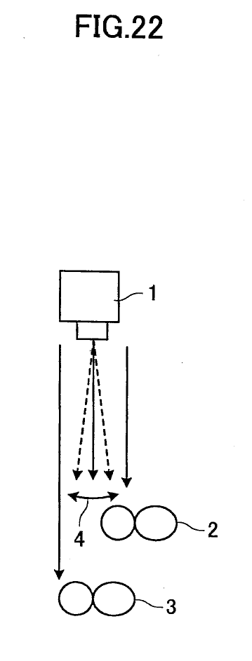

FIG. 23 is an explanation view for explaining the view point swing of the camera swung by the rod portion forming part of the operation support device according to the present invention.

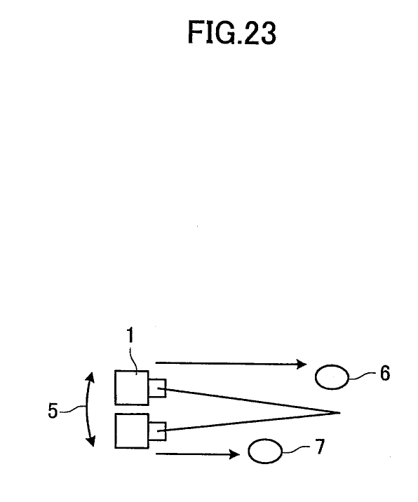

### EXPLANATION OF THE REFERENCE NUMERALS

11: Automotive vehicle
12: Rod portion (Rod-like retaining means)
13: Camera unit (Image taking means)
14: Swing compensation image processing unit (Swing compensation image processing unit, Distance detection means)
15: Image displaying means (Displaying means)
31, 81: Acceleration sensors (Detection means)
42: Imaginary camera unit (Imaginary image taking means)
71: Distance device (Distance means)
121: Oscillation means

### DESCRIPTION OF THE PREFERRED EMBODIMENTS

The embodiments of the operation support device according to the present invention will hereinafter be described with the accompanying drawings.

### First Embodiment

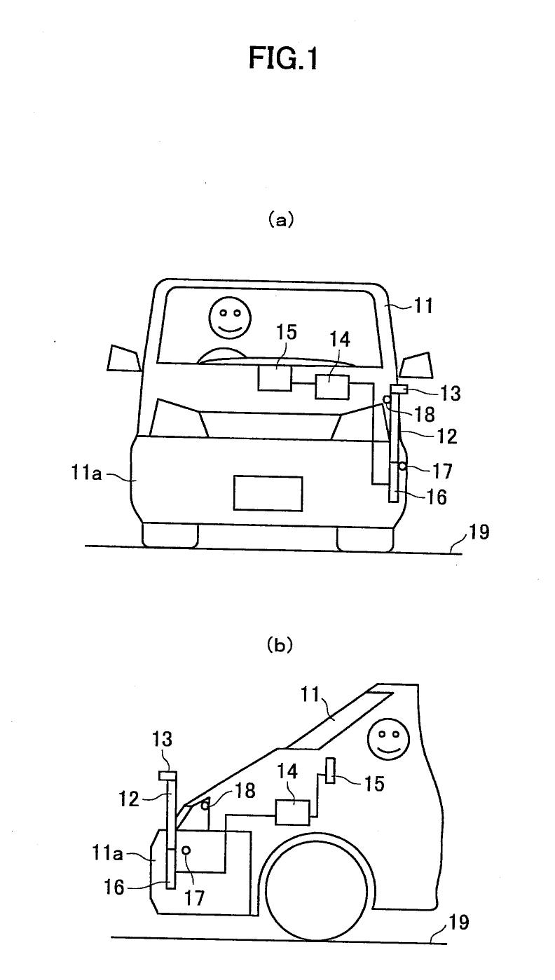

FIGS. 1 to 5 are schematic views showing the first embodiment of the operation support device according to the present invention.

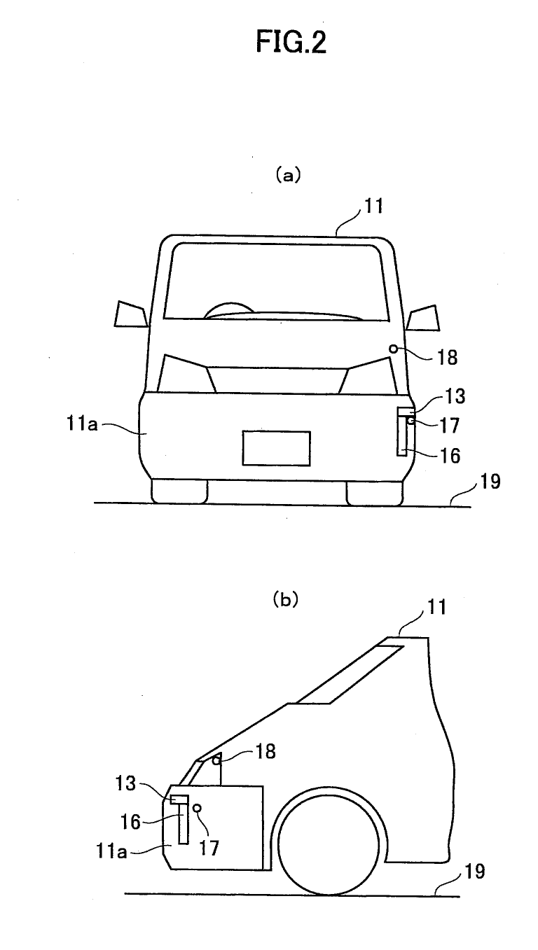

The construction of the first embodiment of the operation support device according to the present invention will be firstly explained. As shown in FIGS. 1 and 2, the operation support device comprises an extendible and contractible rod portion (defined in the present invention as rod-like retaining means) 12 projected from a bumper 11a forming part of an automotive vehicle 11, a camera unit 13 mounted on the top end of the rod portion 12 to serve as image taking means for taking images of one or more objects located around the automotive vehicle 11, a swing compensation image processing unit (defined in the present invention as swing compensation image processing means) 14 having the image inputted therein to compensate the image on the basis of a swing on a special distance plane spaced apart from the camera unit 13, the swing-compensated image being in parallel relationship with the image taken by the camera unit 13, and a display unit (defined in the present invention as display means) 15 provided in the cabin of the automotive vehicle 11 to display the swing-compensated image on a screen.

In this embodiment, the swing compensation image processing unit 14 is adapted to detect a rotational swing and a positional swing of the camera unit 13 provided on the top end of the rod portion 12 by chasing two different particular points on the automotive vehicle 11, and to compensate the image taken by the camera unit 13 by canceling the effect of the rotational and positional swings of the camera unit 13 on the special distance plane spaced apart from the camera unit 13.

The bumper 11a has a rod housing and retaining portion 16 for retaining the rod portion 12 to be longitudinally retracted and accommodated in the rod housing and retaining portion 16 together with the camera unit 13.

More specifically, the rod portion 12 is provided in the left end portion of the bumper 11a of the automotive vehicle 11 so that the rod portion 12 can be projected upwardly of the automotive vehicle 11 before the image is taken by the camera unit 13, thereby making it possible to provide information about the image taken by the camera unit 13 to indicate the dead points and directions in the left side of the automotive vehicle 11 to ensure that the operation by the driver for his or her parking and passing through an narrow space is facilitated. Under the state that the image is not taken by the camera unit 13, the rod portion 12 remains retracted and housed in the rod housing and retaining portion 16 with the camera unit 13 being accommodated in the bumper 11a as will be seen particularly in FIG. 2.

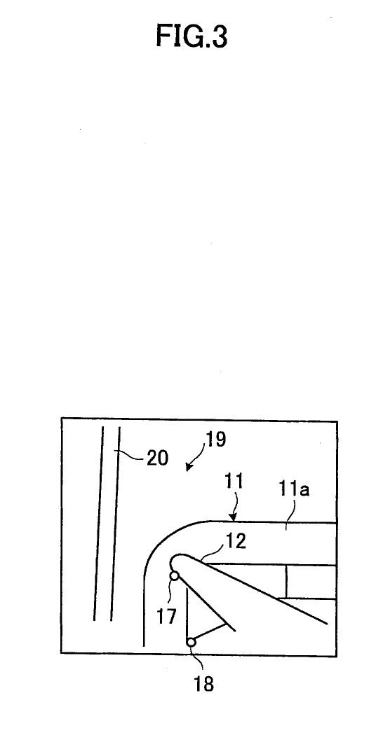

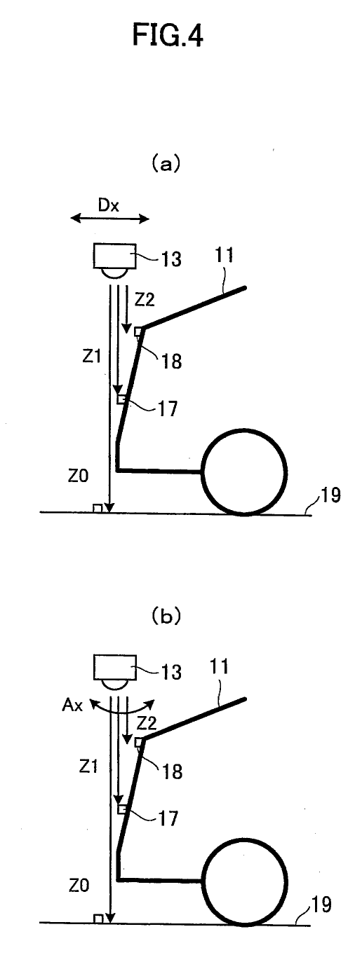

FIGS. 3 and 4 show a swing compensating operation to be carried out by the swing compensation image processing unit 14. The forward portion of the automotive vehicle 11 below the rod portion 12 held under the retracted state of the rod portion 12 shown in FIG. 1 is provided with a pair of markers 17 and 18 upwardly and downwardly spaced apart from each other to take their images shown in FIG. 3 with the camera unit 13 under the state that the rod portion 12 is extended upwardly. Therefore, FIG. 3 shows an image taken by the camera unit 13 for the markers 17 and 18, a road surface 19, white lines 20 on the road surface 19, the rod portion 12, and the bumper 11a of the automotive vehicle 11 driven by a driver

The swing compensation image processing unit 14 is adapted to detect the rotational and positional swings of the camera unit 13 by chasing the markers 17 and 18 through the image taken by the camera unit 13, and to compensate the image taken by the camera unit 13 after estimating the swing on the road surface 19 shown in FIG. 1 on the basis of the detecting results.

This means that the swing-compensated image can be displayed without being affected by the swing on the road surface 19 or the white lines 20 shown in FIG. 3, thereby making it possible for the driver to easily recognize the image at a relatively high level while driving his or her car.

The detailed description about the swing compensating operation will be made with reference to FIGS. 4.

FIGS. 4 are schematic views showing a method of estimating the swing on the road surface 19 by chasing the markers 17 and 18 indicative of two different particular points. The markers 17 and 18 are illustrated in FIG. 4 as being provided on the automotive vehicle 11 in upwardly downwardly spaced-apart relationship with each other with the legends “Z1”, “Z2”, and “Z0” indicating the distances between the camera unit 13 and the marker 17, between the camera unit 13 and the marker 18, and between the camera unit 13 and the road surface 19, respectively.

The camera unit 13 is positioned with its lens directed downwardly, and is assumed to be swung with the swing including a horizontal positional swing “Dx” and a horizontal rotational swing “Ax” while the swing of the image being assumed to be correspondent to a linear addition of these swings “Dx” and “Ax”.

The swings of the images (Dx0, Dx1, Dx2) correspondent to the horizontal positional swings “Dx” are represented by Dx0=Dx·f/Z0, Dx1=Dx·f/Z1, Dx2=Dx·f/Z2 correspondent to the distance “Z” from the camera unit 13, for example, the distance “Z0” between the camera unit 13 and the road surface 19, the distance “Z1” between the camera unit 13 and the marker 17, and the distance “Z2” between the camera unit 13 and the marker 18 ( where “f” is a focus distance). The swing of the image correspondent to the rotational swing “Ax” are represented by Ax0=Ax1=Ax2, irrespective of the distance from the camera unit 13.

The swings (x1, x2) actually observed at the two different particular points of the automotive vehicle 11 are respectively represented by the linear addition x1=Dx1+Ax1, x2=Dx2+Ax2. This means that the swing on the road surface 19, X0=Dx0+Ax0 is assumed to be X0=(X2−X1)·Z2·Z1/(Z0(Z1−Z2))+(Z1·X1−Z2·X2)/(Z1−Z2).

The swing compensation image processing unit 14 can produce an output image compensated with the input image being moved in parallel relationship with the actual image at a compensation amount correspondent to the assumed swing “X0” on the road surface 19. In reality, the image to be processed is two-dimensional (X, Y) information so that if the image is compensated with the swing in the “X” direction indicative of a lateral direction, the image can readily be compensated with the swing in the “Y” direction indicative of a longitudinal direction in the same manner as that of the image compensated in the “X” direction. It is therefore to be noted from the foregoing description that the swing compensation image processing unit 14 can compensate the swings in the “X” and “Y” directions.

The method mentioned in the above is effective for the image closed to the light axis of the camera unit 13, but can effectively enhance a visibility to a relatively high level for the images remote from the light axis of the camera unit 13 with the swings compensated as small as possible, for example, the input swing being compensated in the range from its one half to its one fourth possibly reduced since the remote images are each apt to have an error in the compensation amount increased in response to the distance between the image to be taken by the camera unit 13 and the light axis of the camera unit 13.

The first embodiment of the operation support device thus constructed comprises a rod portion 12 projected from the automotive vehicle 11, a camera unit 13 mounted on the top end of the rod portion 12 to serve as an image taking means for taking an image of an object around the automotive vehicle 11, a swing compensation image processing unit 14 inputted therein with the image taken by the camera unit 13 to output a signal indicative of the image compensated by a compensation amount “X0” corresponding to a swing from its home position on the road surface 19 ( special plane) from the camera unit 13, the swing being caused by the movement of the camera unit 13 with the compensated image being moved in parallel relationship with the image taken by the camera unit 13. This results in the fact that the swing of the image of the object to be taken on the road surface 19 can be reduced to a level as small as possible, thereby producing an image excellent in quality even if the rod portion 12 is swung with the camera unit 13 concomitantly being swung by the rotational swing “Ax” and the positional swing “Dx”.

Especially, the swing compensation image processing unit 14 exemplified in the embodiment of the operation support device according to the present invention is adapted to chase two different particular points such as for example the markers 17 and 18 provided on the automotive vehicle 11 to detect the rotational swing “Ax” and the positional swing “Dx” of the camera unit 13 provided on the top end of the rod portion 12, thereby making possible for the swing of the image from the camera unit 13 to the road surface 19 to effectively be cancelled and compensated and thus producing an image excellent in quality even if the rod portion 12 is swung with the camera unit 13 concomitantly being swung by the rotational swing “Ax” and the positional swing “Dx”.

In addition, the swing compensation image processing unit 14 exemplified in the embodiment of the operation support device according to the present invention comprises a display unit 15 for displaying an image compensated in response to the swing of the camera unit 13 to ensure that the surrounding objects and situations around the automotive vehicle 11 is readily recognized by the driver, thereby providing an enhanced drive safety to the driver.

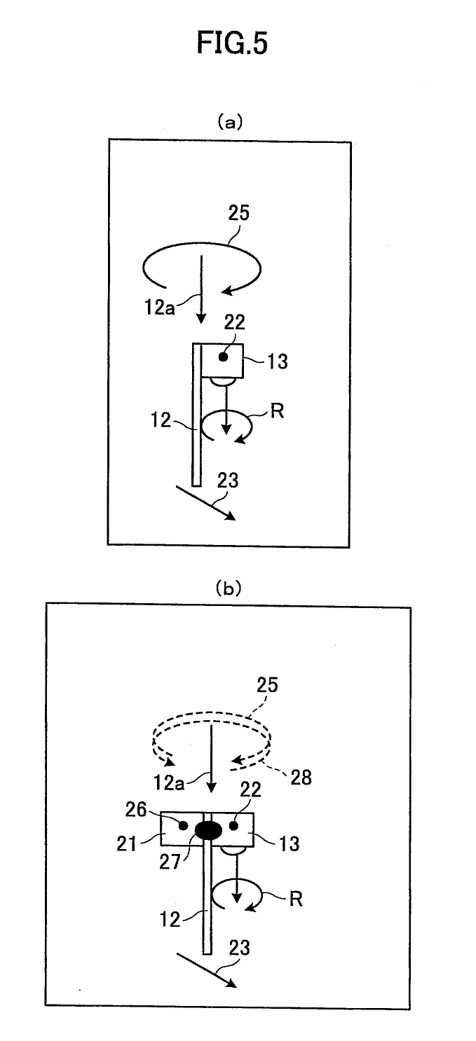

The swing compensation image processing unit 14 exemplified in the embodiment of the operation support device according to the present invention is adapted to output a signal indicative of the image compensated by a compensation amount “X0” corresponding to a swing from its home position on the road surface 19 (special plane) from the camera unit 13, the swing being caused by the movement of the camera unit 13 and the image to be compensated being moved in parallel relationship with the image taken by the camera unit 13, so that the swing compensation image processing unit 14 is not available for the rotational swing “Ax” of the camera unit 13 around the center axis of the camera unit 13. In this case, the camera unit 13 is required not to be swung by the rotational swing “Ax” around the center axis of the camera unit 13 as will be seen from FIG. 5.

In order to have the camera unit 13 not swung around the center axis of the camera unit 13, a counter weight 21 is required to be mounted on the top end of the rod portion 12 in opposing relationship with the camera unit 13 across the center axis of the rod portion 12.

The above-mentioned swing compensating method is of compensating the positional swings with the images being moved in parallel relationship with each other independently in the “X” and “Y” directions. As will be understood from the foregoing description, the camera unit 13 is swung around the center axis of the rod portion 12 by the rotational swing “R” other than the positional swing. For the rotational swing “R”, the above-mentioned swing compensating method cannot compensate the rotational swing “R” only with the images being moved in parallel relationship with each other independently in the “X” and “Y” directions as the images are swung by rotational swing “R” at the center of the display unit 15.

In the case that the camera unit 13 is mounted on the top end of the rod portion 12 with the gravity position 22 of the camera unit 13 being spaced apart from the center axis 12a of the rod portion 12 in FIG. 5, the acceleration and deceleration of the automotive vehicle 11 generated in the direction 23 cause a rotation moment 25 between the gravity position 22 of the camera unit 13 and the center axis 12a of the rod portion 12, thereby resulting in causing the rotational swing “R”.

For the purpose of lessening the rotational swing “R” to a minimum level, the counter weight 21 is mounted on the top end of the rod portion 12 with the gravity position of the counter weight 21 being in symmetrical relationship with the gravity position of the camera unit 13 to have the gravity position formed by the addition of the gravity position of the counter weight 21 and the gravity position of the camera unit 13 positioned in registry with and on the center axis 12a of the rod portion 12. The counter weight 21 and the camera unit 13 thus provided make it possible to cancel the rotation moments of the camera unit 13 and the counter weight 21 caused by the acceleration and the deceleration of the automotive vehicle 11 generated in the direction 23 so that the rotational swing “R” of the camera unit 13 around the light axis of the camera unit 13 can be lessened to almost zero level and can produce an image compensated to a desirable and high level in compensation quality.

### Second Embodiment

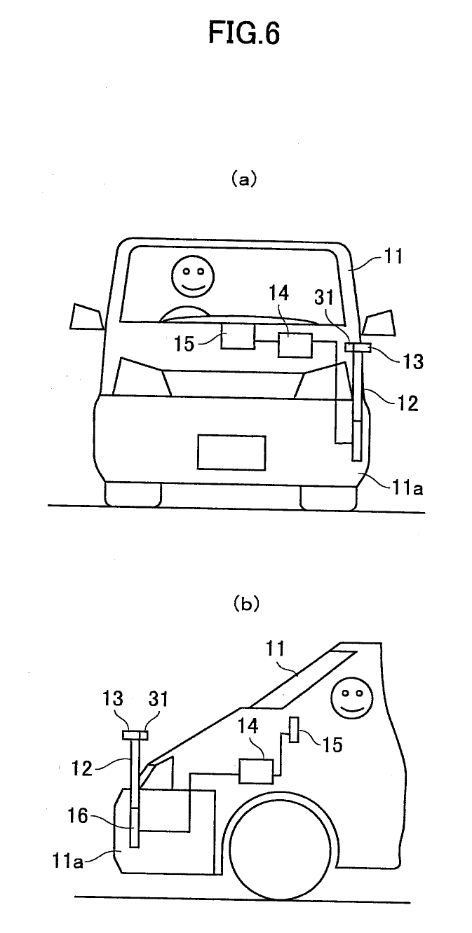

FIGS. 6 to 10 show the second embodiment of the operation support device according to the present invention. There will be no description about the detailed construction of the second embodiment of the operation support device according to the present invention except for the elements or parts of the second embodiment different from those of the first embodiment but bearing the same reference numerals as those of the elements or parts of the first embodiment.

The second embodiment of the operation support device according to the present invention is shown in FIG. 6 as comprising an acceleration sensor (defined in the present invention as being a detection means) 31 on the top end of the rod portion 12 to occupy a position the same as that of the camera unit 13 to detect positional and rotational swings of the camera unit 13, and to output swing information about the positional and rotational swings of the camera unit 13 to the swing compensation image processing unit 14.

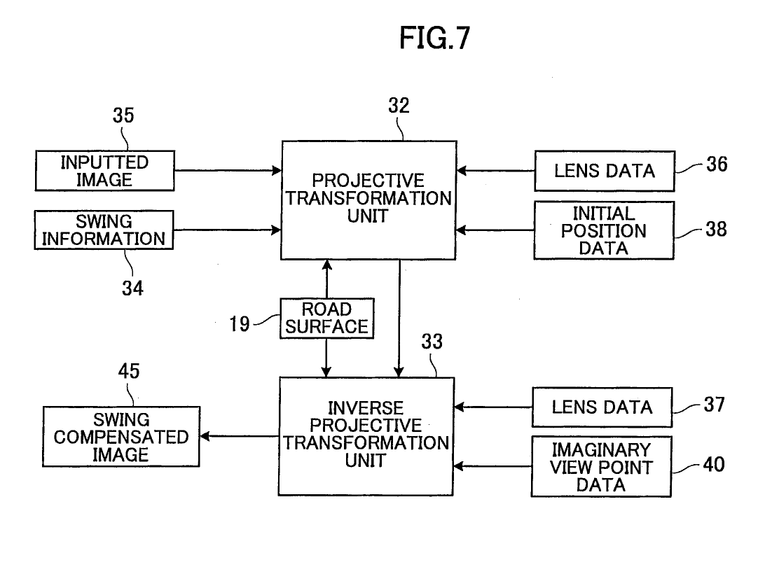

As shown in FIG. 7, the swing compensation image processing unit 14 in this embodiment comprises a projective transformation unit 32 and an inverse projective transformation unit 33. The projective transformation unit 32 is adapted to perform the projective transformation of the image taken by the camera unit 13 to produce an image projected on a special distance plane, such as for example a road surface 19, spaced apart from the camera unit 13. The inverse projective transformation unit 33 is adapted to perform the inverse projective transformation of the projected image, and to produce in image to be displayed as an image to be taken by the imaginary camera unit without the effect of the rotational and positional swings of the camera unit 13.

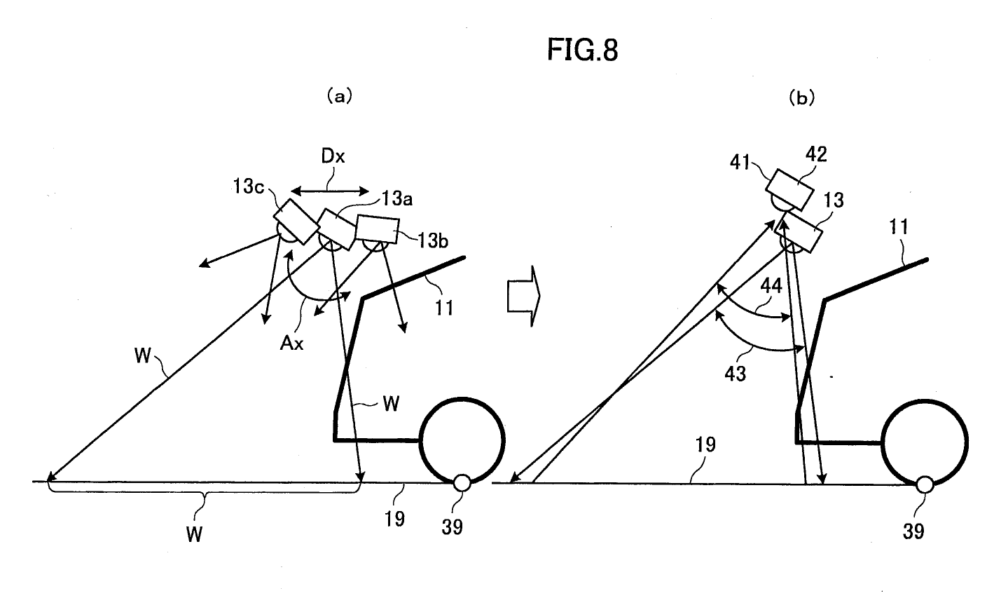

The detailed description about the swing compensating operation will be made with reference to FIGS. 7 and 8.

FIG. 7 is a block diagram showing a swing compensation image processing unit 14, while FIG. 8 is a schematic view for explaining how the swing compensation is carried out by the swing compensation image processing unit 14. The camera unit 13 is shown in FIG. 8 as being disposed with its light axis being inclined somewhat leftwardly and forwardly from the downward direction of the camera unit 13.

The driving operation by the driver causes the camera unit 13 to be swung by the positional swing “Dx” and the rotational swing “Ax”, while the positional swing “Dx” and the rotational swing “Ax” of the camera unit 13 is detected by the acceleration sensor 31. The swing information about the positional swing “Dx” and the rotational swing “Ax” of the camera unit 13 is then outputted to the swing compensation image processing unit 14.

The swing compensation image processing unit 14 is then operated to compensate the image 35 taken by the camera unit 13 by reducing the effect of the rotational and positional swings of the camera unit 13 in compliance with an algorism shown in FIG. 7 on the basis of the swing information 34 about the positional swing “Dx” and the rotational swing “Ax” of the camera unit 13 received from the acceleration sensor 31. The compensated images are then outputted by the swing compensation image processing unit 14.

The camera unit 13 exemplified in the present embodiment of the operation support device according to the present invention has a wide-angle lens with a horizontal angle in the range of 110 to 140 degrees. In general, it is unavoidable for the wide-angle lens to have an inherent lens deformation. Therefore, the swing compensation image processing unit 14 has lens data 36 about a field angle, a lens deformation, and the like inherent to the wide-angle lens.

The operation of the operation support device according to the second embodiment of the present invention is performed through the steps of calculating, by using the swing information 34 about the positional swing “Dx” and the rotational swing “Ax” of the camera unit 13 received from the acceleration sensor 31, positions and directions of the camera unit 13 at the time of having the camera unit 13 take images 35, compensating the image with the data about the lens deformation of the wide-angle lens, compensating the image with the position and the direction of the camera unit 13, and having the projective transformation unit 32 produce an image to be projected on the road surface 19 spaced apart from the camera unit 13.

As will be seen from FIG. 8, the camera unit 13 occupies the initial position 13a under the condition that the rod portion 12 is not being swung with the camera unit 13. On the other hand, the camera unit 13 occupies a position 13b or a position 13c changed with the positional swing “Dx” and the rotational swing “Ax”. Therefore, the projective transformation of the image taken by the camera unit 13 is performed by the projective transformation unit 32 on the basis of the position to be occupied by the camera unit 13 at the time of having the camera unit 13 take that image.

The transformed image is produced from the projected image by the inverse projective transformation unit 33 as an image taken by the imaginary camera unit 42 defined as imaginary image taking means with lens data 37 and located at a position and in a direction represented by imaginary view point data 40.

As shown in FIG. 8, the inverse projective transformation unit 33 is operated to synthesize a swing-compensated image, as an image taken by the imaginary camera unit 42 located at an imaginary view point 41 with lens data 37, from the image projected on the road surface 19 and indicated by a legend “M”.

From the above-mentioned operations, it will be understood that the operation support device according to the second embodiment of the present invention can produce a swing-compensated image to be displayed at a relatively high quality with the reduced effect of the rotational and positional swings of the camera unit 13 on the special distance plane by reason that the image taken by the camera unit 13 can be compensated at the time of performing the projective transformation of the image to be taken by the camera unit 13.

The operation support device according to the second embodiment of the present invention can produce a swing-compensated image to be displayed at a relatively high quality with the reduced effect of the swing of the camera unit 13 by reason that the image taken by the camera unit 13 is compensated on the basis of the lens data 36 even if the image has part deformed by the camera unit 13.

The operation support device according to the second embodiment of the present invention can reduce the effect of the rotational and positional swings of the camera unit 13 on the special distance plane, i.e., the road surface 19, even if the camera unit 13 is disposed with its light axis inclined somewhat leftwardly and forwardly from the downward direction of the camera unit 13, by reason that the projective transformation unit 32 is adapted to produce an image projected to the road surface 19, the inverse projective transformation unit 33 is adapted to produce an image viewed from the imaginary view point 41 from the image projected to the road surface 19. This means that the operation support device according to the second embodiment of the present invention can allow the driver to notice an obstacle that is within a field wider than the field defined in the first embodiment.

The direction and the position represented by the imaginary view point data 40 may be the same as the initial direction and the initial position to be occupied by the camera unit 13 with no swing, or may be different from the initial direction and the initial position to be occupied by the camera unit 13.

The lens data 37 may be the same as the lens data 36 corresponding to the lens in the camera unit 13, or may be different from the lens data 36 corresponding to the lens in the camera unit 13.

In the operation support device according to the second embodiment of the present invention, the acceleration sensor 31 is adapted to detect the positional swing “Dx” and the rotational swing “Ax” of the camera unit 13. However, the operation support device according to the second embodiment of the present invention may be adapted to detect the positional swing “Dx” and the rotational swing “Ax” of the camera unit 13 by chasing the markers 17 and 18 defined in the first embodiment as characteristic portions forming part of the automotive vehicle 11.

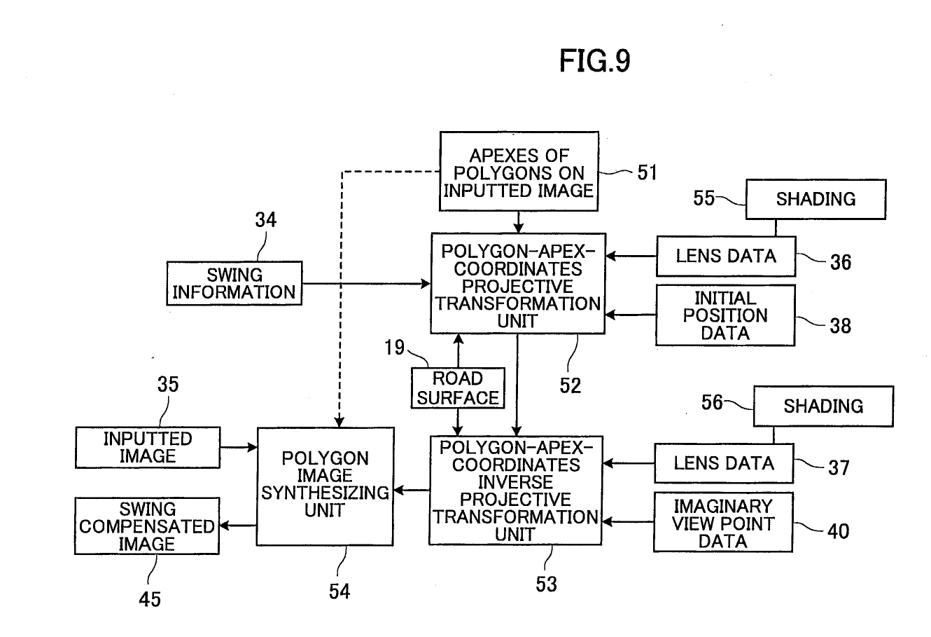

In this embodiment, two projective transformations of the image are performed by the projective transformation units 32 and 33 on the basis of the construction shown in FIG. 7. However, one projective transformation of the image may be performed on the basis of the construction shown in FIG. 9.

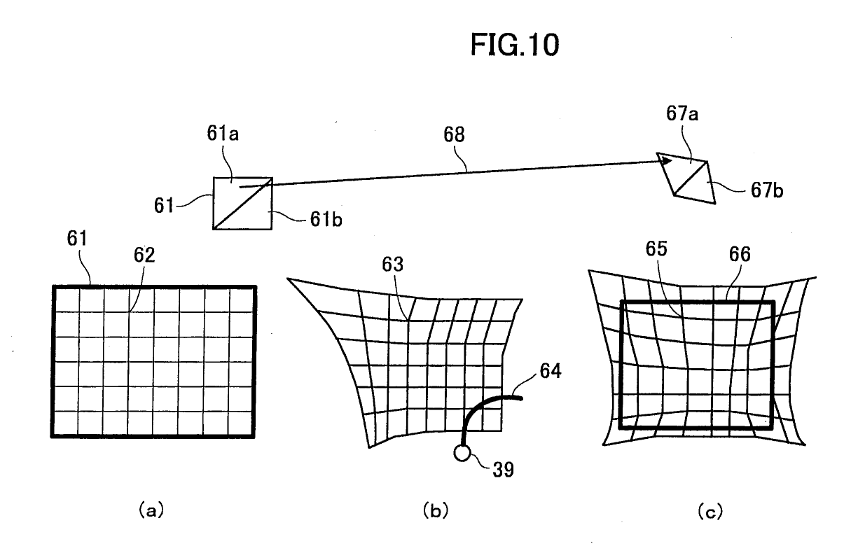

The detailed description about the swing compensating method will be made with reference to FIGS. 9 and 10. As shown in FIG. 10, the inputted image is divided into eight-by-six rectangle portions, and sampled at apexes of the rectangle portions as those of polygons.

In this embodiment, each of the polygons has the shape of triangle. As shown in FIG. 10(a), the rectangle portion 61 is divided into two triangle sections 61a and 61b. This means that the inputted image shown in FIG. 10(a) is sampled at apexes of nine-by-seven polygons.

As shown in FIG. 9, the coordinates of the apexes of the polygons projected on the road surface 19 are calculated by the polygon-apex-coordinates projective transformation unit 52 from the swing information 34, the lens data 36, initial position data 38, polygon apex data 51 about the coordinates of the apexes of the polygons on the inputted image.

FIG. 10(b) is a schematic view showing the positions of the apexes of the polygons projected on the road surface 19. As an example, the apex 62 of one of the polygons shown in FIG. 10(a) is transformed into the apex 63 of one of the polygons on the road surface 19 in FIG. 10(b). As shown in FIG. 10(b), the position 64 of the bumper 11a projected on the road surface 19 leads to the reference point 39 on the road surface 19.

In FIG. 9, the polygon-apex-coordinates inverse projective transformation unit 53 is operated to perform, on the basis of the lens data 37 and the imaginary view point data 40, the inverse projective transformation of polygon-apex data indicative of the coordinates of the apexes of the polygons on the road surface 19 shown in FIG. 10(b) into the coordinates of the apexes of the polygons on an image shown in FIG. 10(c) and taken by the imaginary camera unit 42 shown in FIG. 8.

In this step, the coordinates of the apexes of the polygons on the road surface 19 are transformed into the coordinates of the apexes of the polygons on an image shown in FIG. 10(c) and taken by the imaginary camera unit 42 by using the swing information 34, the lens information 36, and the initial position data 38 indicative of the initial position of the camera unit 13. Here, the coordinates of the apexes of the polygons located not only inside but also outside of the frame 66 of the image shown in FIG. 10(c) and taken by the imaginary camera unit 42 are calculated by the polygon-apex-coordinates inverse projective transformation unit 53. As shown in FIG. 9, the polygon image synthesizing unit 54 is operated to produce a swing-compensated image 45 by transforming the inputted image with polygon-apex data indicative of the coordinates of the apexes of the polygons on an image shown in FIG. 10(c) and taken by the imaginary camera unit 42 and the coordinates of the apexes of the polygons on the inputted image.

The triangle polygons 61a and 61b of the rectangular portion 61 on the inputted image are transformed into triangle polygons 67a and 67b shown in FIG. 10(c) through the projective transformation. Therefore, the picture elements in those triangle polygons 61a and 61b are linearly projected on respective elements in those triangle polygons 67a and 67b on the basis of affine transformation 66.

The operation support device according to the second embodiment of the present invention can produce a swing-compensated image having a natural shading characteristic by reason that the lens data 36 includes shading data 55 indicative of its shading characteristic. The operation support device according to the second embodiment of the present invention can produce an image having shading characteristic by attaching gain data to the polygon- apex data, and multiplying the coordinates of the apexes of the polygons by respective gains represented by the attached gain data.

The operation support device according to the second embodiment of the present invention can produce a synthetic image having a natural shading characteristic from the swing-compensated image by reason that the lens data 37 of the imaginary camera unit 42 has shading data 56 for its imaginary lens.

### Third Embodiment

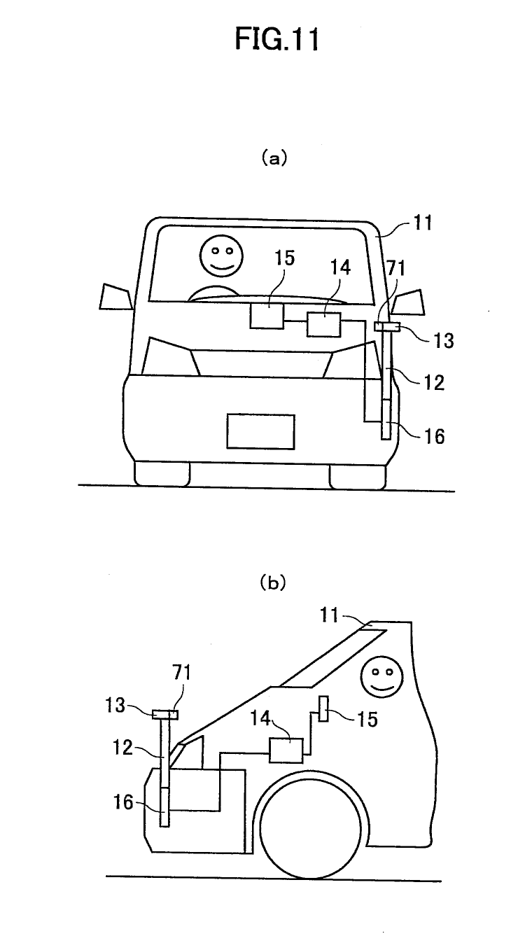

FIGS. 11 to 13 show the third embodiment of the operation support device according to the present invention. There will be no description about the detailed construction of the third embodiment of the operation support device according to the present invention except for the elements or parts of the third embodiment different from those of the first or second embodiment but bearing the same reference numbers as those of the elements or parts of the first or second embodiment.

The third embodiment of the operation support device according to the present invention is shown in FIG. 11 as comprising a distance device (defined in the present invention as being distance means) 71 on the top end of the rod portion 12 to occupy a position the same as that of the camera unit 13. The distance device 71 is adapted to estimate a distance to an object in a field angle 72 of the camera unit 13, and to produce distance data to be outputted to the swing compensation image processing unit 14, this distance data being indicative of the estimated distance to the object.

The swing compensation image processing unit 14 is adapted to change the special distance plane on the basis of the distance data received from the distance device 71, while the display unit 15 is adapted to display a swing-compensated image outputted by the swing compensation image processing unit 14 with obstacle warning about a bumper, a road surface 19 or the like detected by the distance device 71.

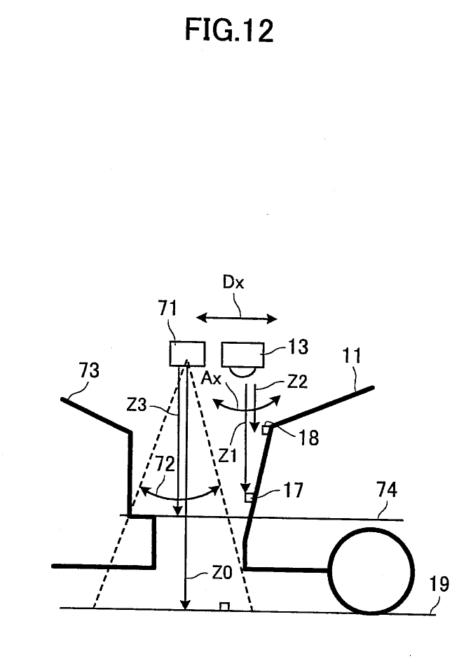

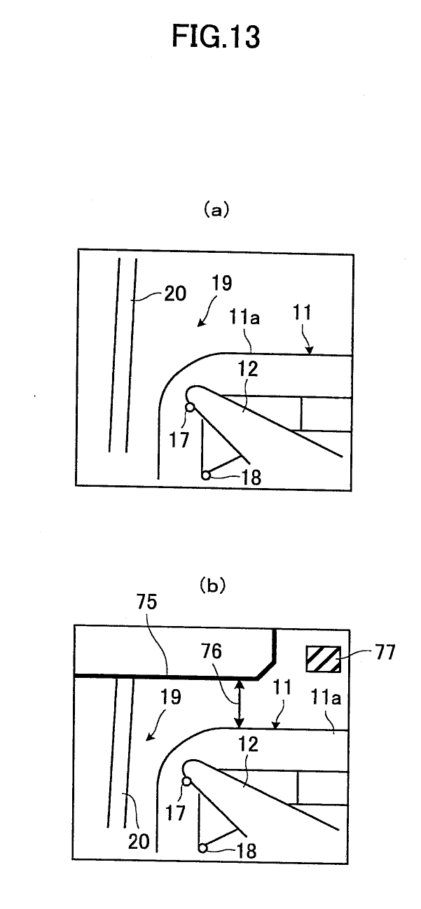

The detailed description about the swing compensating operation will be made with reference to FIGS. 12 and 13.

When there is no object within the field angle 72 of the camera unit 13, the distance data indicative of the distance “Z0” to the road surface 19, i.e., the nearest object other than the automotive vehicle 11 is outputted by the distance device 71. Additionally, the image is partially masked as being indicative of the automotive vehicle 11 in a preliminary step.

In a manner similar to the manner mentioned in the first embodiment, the swing “X0” on the road surface 19 is then estimated by a following equation by the swing compensation image processing unit 14 from the swings “X1” and “X2” of the markers 17 and 18 indicative of two different particular points. The swing compensation image processing unit 14 is then operated to compensate the image by shifting the image in a direction against the estimated swing “X0”, the swing-compensated image being in parallel relationship with the image taken by the camera unit 13.

X0=(X2−X1)·Z2·Z1/(Z0(Z1−Z2))+(Z1·X1−Z2·X2)/(Z1−Z2)

When, on the other hand, there is an automotive vehicle 73 within the field angle 72 of the camera unit 13 as shown in FIG. 12, the distance data indicative of the distance “Z3” to the bumper of the automotive vehicle 73, i.e., the nearest object other than the automotive vehicle 11 is outputted by the distance device 71. Additionally, the image is partially masked as being indicative of the automotive vehicle 11 in a preliminary step.

In a manner similar to the manner mentioned in the first embodiment, the swing “X3” on a plane 74 distant from the camera unit 13 is then estimated by a following equation by the swing compensation image processing unit 14 from the swings “X1” and “X2” of the markers 17 and 18 indicative of two different particular points. The image is then compensated by the swing compensation image processing unit 14 on the basis of a method of shifting the image in a direction against the swing “X3”.

X3=(X2−X1)·Z2·Z1/(Z3(Z1−Z2))+(Z1·X1−Z2·X2)/(Z1−Z2)

From the foregoing description, it will be understood that the operation support device according to the third embodiment of the present invention can produce an image to be displayed at a relatively high quality with the reduced swing on the road surface 19, even if there is no obstacle in the field angle 72 of the camera unit 13, by comprising a distance device 71 on the top end of the rod portion 12 to occupy a position the same as that of the camera unit 13, the distance device 71 being adapted to estimate a distance to an object in a field angle 72 of the camera unit 13, and to produce distance data to be outputted to the swing compensation image processing unit 14, this distance data being indicative of the estimated distance to the object, the swing compensation image processing unit 14 being adapted to change the special distance plane on the basis of the distance data received from the distance device 71.

When, on the other hand, there is an automotive vehicle 73 within the field angle 72 of the camera unit 13, the operation support device according to the third embodiment of the present invention can produce an image to be displayed at a relatively high quality with the reduced swing on a special distance plane defined with the detected obstacle.

On the other hand, FIG. 13 is a schematic view showing images to be displayed by the display unit 15. FIG. 13(a) is a schematic view showing an image to be clearly displayed with the reduced effect of the swing of the camera unit 13. This image is indicative of the road surface 19, the white lines 20, and parts of the automotive vehicle 11.

FIG. 13(b) is a schematic view showing an image taken when the obstacle 75 such as a bumper of an automotive vehicle 73 enters into the field angle 72 of the camera unit 13. The operation support device according to the third embodiment of the present invention can allow the driver to recognize the distance 76 between the automotive vehicle 11 and the obstacle 75 with no difficulty, and allow the driver to drive the automotive vehicle 11 with a relatively high safety by reason that the image is clearly displayed by the display unit 15 without being deteriorated by the swing of the camera unit 13, the obstacle 75 represented by the image being clear in comparison with the road surface 19, the white lines 20, and part of the automotive vehicle 11. The operation support device according to the third embodiment of the present invention can allow the driver to recognize the distance 76 between the automotive vehicle 11 and the obstacle 75 with no difficulty, and allow the driver to drive the automotive vehicle 11 with a relatively high safety. Additionally, the operation support device according to the third embodiment of the present invention can inform the driver about whether or not there is an obstacle such as for example a bumper forming part of the automotive vehicle 73 within the field angle 72 of the camera unit 13, and allow the driver to notice an obstacle which is within the field angle 72 of the camera unit 13, by blinking part 77 of the image as an obstacle warning signal.

In general, the driver cannot watch at frequent intervals the image displayed on the screen of the display unit 15 under the condition that the driver is operating the automotive vehicle 11. However, the operation support device according to the third embodiment of the present invention can securely inform the driver about whether or not there is an obstacle such as for example a bumper forming part of the automotive vehicle 73 within the field angle 72 of the camera unit 13, and allow the driver to notice an obstacle which in within the field angle 72 of the camera unit 13, by blinking part 77 of the image as an obstacle warning signal.

### Fourth Embodiment

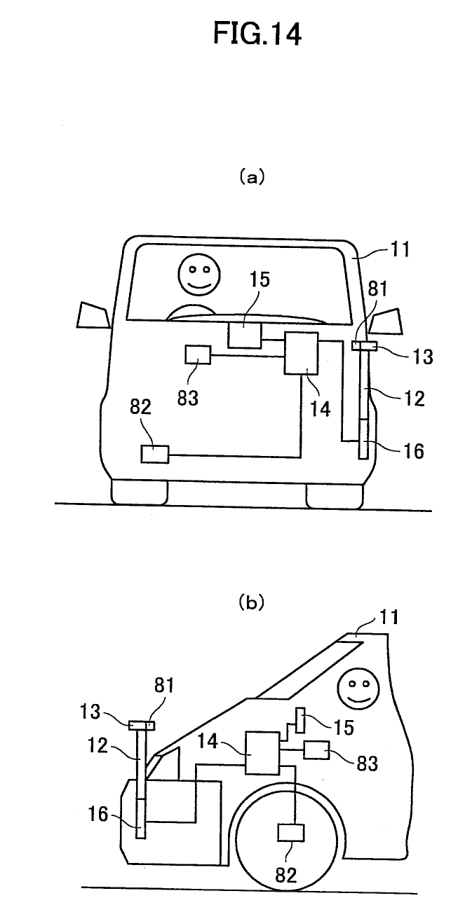

FIGS. 14 to 18 are schematic views showing the fourth embodiment of the operation support device according to the present invention. There will be no description about the detailed construction of the fourth embodiment of the operation support device according to the present invention except for the elements or parts forming part of the fourth embodiment different from those of the first or second embodiment but bearing the same reference numbers as those of the first or second embodiment.

The operation support device according to the fourth embodiment of the present invention is shown in FIG. 14 comprises an acceleration sensor (defined in the present invention as a detecting means) 81 on the top end of the rod portion 12 to occupy a position the same as the position of the camera unit 13 to detect the positional and rotational swings of the camera unit 13, a steering angle sensor 82 for detecting a steering angle, and a wheel speed sensor 83 for detecting a wheel speed.

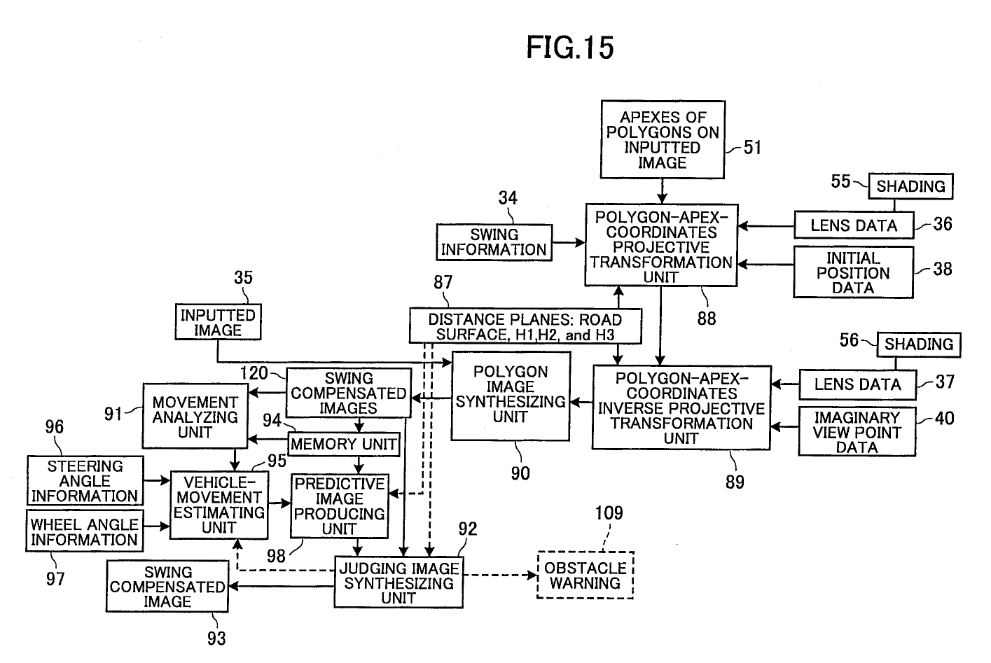

As shown in FIG. 15, the swing compensation image processing unit 14 includes a polygon-apex-coordinates projective transformation unit 88, a polygon-apex-coordinates inverse projective transformation unit 89, a polygon image synthesizing unit 90, a movement analyzing unit 91, a judging image synthesizing unit 92, a vehicle-movement estimating unit 95, and a predictive image producing unit 98.

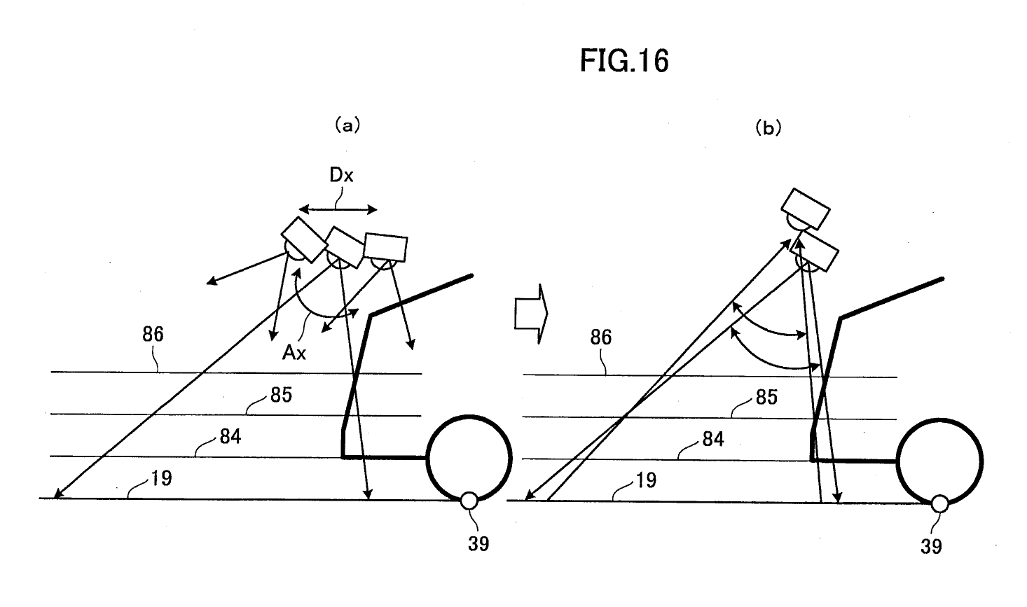

In this embodiment, planes 84, 85, and 86 spaced apart from the road surface 19, and shown in FIG. 16 are defined as special distance planes 87 shown in FIG. 15. The polygon-apex-coordinates projective transformation and inverse projective transformation units 88 and 89 are adapted to perform the transformation of the coordinates of the apexes of the polygons, while the polygon image synthesizing unit 90 is adapted to produce swing-compensated images 120 which can be compensated on the planes 84, 85, and 86.

The polygon image synthesizing unit 90 is adapted to output the swing-compensated images 120 to a memory unit 94, the movement analyzing unit 91, and the judging image synthesizing unit 92. The movement analyzing unit 91 is adapted to analyze the movement of the automotive vehicle 11 by comparing the current swing-compensated images with the previous swing-compensated images stored in the memory unit 94, and to output analysis information about the estimation information on the movement of the automotive vehicle 11 to the vehicle-movement estimating unit 95.

The vehicle-movement estimating unit 95 is adapted to estimate the movement of the automotive vehicle 11 on the basis of steering angle information 96 produced by the steering angle sensor 82 and wheel speed information 97 produced by the wheel speed sensor 83, and to calibrate estimation information on the basis of the analysis information received from the movement analyzing unit 91, and to output the calibrated estimation information to the predictive image producing unit 98.

The predictive image producing unit 98 is adapted to produce predictive images corresponding to the respective special distance planes 87 on the basis of the calibrated estimation information received from the vehicle-movement estimating unit 95. The judging image synthesizing unit 92 is adapted to compare the swing-compensated images 120 with the predictive images corresponding to the special distance planes 87, and to produce an image from the swing-compensated image 93 the same as, or closely similar to any one of the predictive images corresponding to the special distance planes 87.

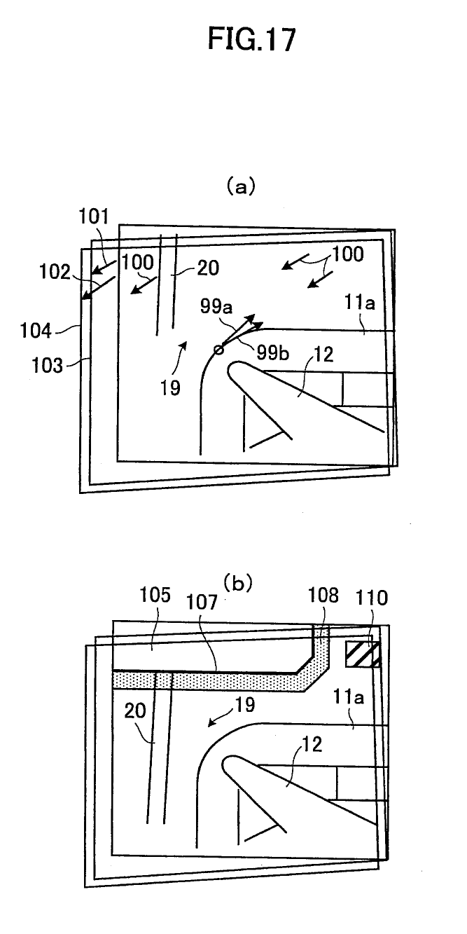

FIGS. 17 are schematic views for explaining the above-mentioned functions, (a) showing the image compensated on the road surface 19. When the automotive vehicle travels in the direction of an arrow 99a or an arrow 99b, the road surface 19 moves with respect to the automotive vehicle 11 in the direction of an arrow 100 opposite to the arrow 99a or the arrow 99b.

The above-mentioned movement can be detected by the movement analyzing unit 91 through the steps of comparing the current swing compensation image with the prior swing compensation image. On the other hand, the movement of the automotive vehicle 11 is estimated on the basis of steering angle information 96 produced by the steering angle sensor 82 and wheel speed information 97 produced by the wheel speed sensor 83.

In FIG. 17(a), the movement of the automotive vehicle 11 estimated on the basis of the steering angle information 96 and the wheel speed information 97 is indicated by an arrow 99a. However, this estimation results on the movement 99b of the automotive vehicle 11 has an error resulting from a skid or the like. The vehicle-movement estimating unit 95 is required to reduce the error of the estimated movement of the automotive vehicle 11 by calibrating the estimated movement of the automotive vehicle 11 on the basis of the analysis results 100 received from the movement analyzing unit 91, and to output the calibrated estimation results on the movement 99b of the automotive vehicle 11 to the predictive image producing unit 98.

In the predictive image producing unit 98, the predictive images corresponding to the special distance planes 87 are produced on the basis of the calibrated estimation results on the movement 99b of the automotive vehicle 11. When the image corresponding to the road surface 19 is moved in the direction of an arrow 101 in FIG. 17(a) under the condition that the automotive vehicle 11 travels in the direction of the arrow 99b opposite to the arrow 101, the image corresponding to the plane spaced apart from the road surface 19 with a height “H1” being moved in the direction of an arrow 102. In other words, the effect of the swing of the camera unit 13 on that plane depends on the distance between the camera unit 13 and that plane. Accordingly, the prior swing-compensated images are moved in the directions of the reference numbers 103 and 104 in order to obtain images predicted to the current swing-compensated images.

The judging image synthesizing unit 92 is operated to compare the swing-compensated images with the predictive images corresponding to the special distance planes 87, and to produce one image from one swing-compensated image closely similar to the predictive image corresponding to one special distance plane. It is preferable to select the swing-compensated image corresponding to one special distance plane closest to the road surface 19 under the condition that there is no edge on the swing-compensated image closely similar to the predictive image.

As will be seen from FIG. 17(b), the swing-compensated image corresponding to the road surface 19 is selected by the judging image synthesizing unit 92 by reason that the predictive image is closely similar to the swing-compensated image corresponding to the road surface 19.

When, on the other hand, the obstacle 105 such as the bumper of the automotive vehicle is in the field angle of the camera unit 13, the swing-compensated image corresponding to the special distance plane spaced from the road surface 19 is selected by the judging image synthesizing unit 92 by reason that the predictive image is closely similar to, or substantially the same as the swing-compensated image corresponding to the special distance plane H1 spaced from the road surface 19.

The swing-compensated image 93 is synthesized from portions of the selected swing-compensated images, and outputted by the judging image synthesizing unit 92. This swing-compensated image 93 has a buffer portion 108 defined between the portion of the swing-compensated image corresponding to the road surface 19 and the portion of the swing-compensated image corresponding to the special distance plane spaced from the road surface 19 by reason that the boundary between of the portion of the swing-compensated image corresponding to the road surface 19 and the portion of the swing-compensated image corresponding to the special distance plane spaced from the road surface 19 is emphasized in swing-compensated image 93. This buffer portion 108 of the swing-compensated image 93 is synthesized from the weighted portions of the selected swing-compensated images.

The judging image synthesizing unit 92 is adapted to receive, as a feedback, the analytical result from the vehicle-movement judging unit 95 to estimate the movement of the automotive vehicle 11 on the basis of the feedback by reason that the vehicle-movement judging unit 95 is adapted to perform the analysis of the movement of the automotive vehicle 11 to detect which part of the image is closely similar to the image compensated on the special distance plane 87.

The judging image synthesizing unit 92 may be adapted to judge whether or not there is an obstacle in the vicinity of the automotive vehicle 11 by detecting which part of the image is closely similar to the image compensated on the special distance plane 87. Additionally, the obstacle warning unit 109 may be adapted to inform about an obstacle located around the automotive vehicle 11 on the basis of the judgment made by the judging image synthesizing unit 92, and to blink part of the image as an obstacle warning sign 110 as shown in FIG. 17(b), or to superimpose obstacle information on the buffer portion 108 shown in FIG. 17(b).

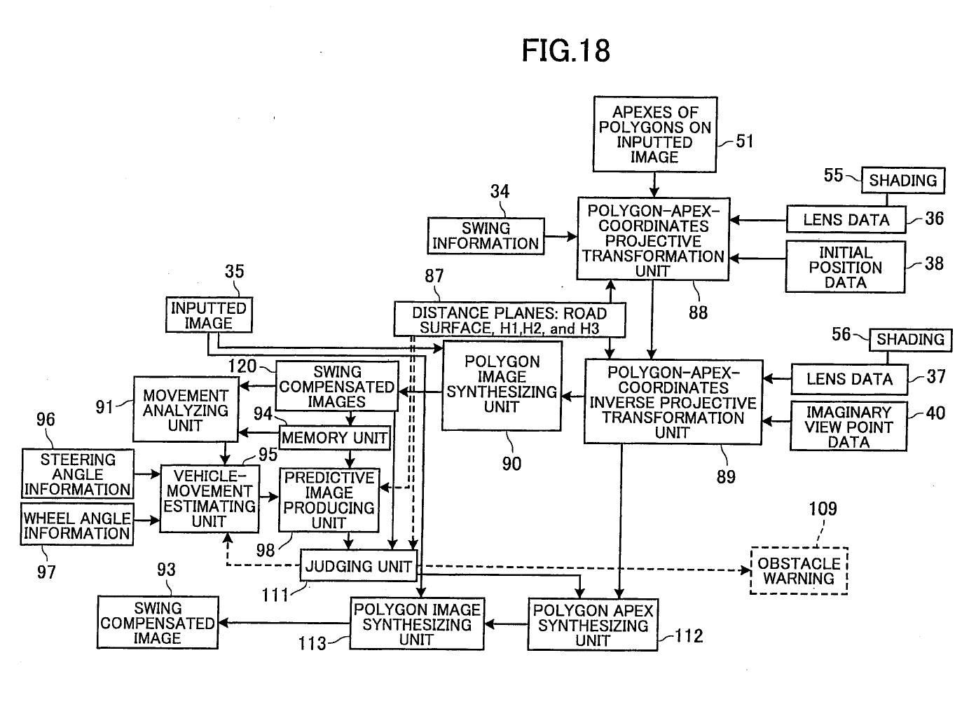

In this embodiment, the judging image synthesizing unit 92 is adapted to judge whether or not each of the swing-compensated images 120 is closely similar to each of the predictive images corresponding to the special distance planes. However, the operation support device may comprise constitutional elements shown in FIG. 18.

From the foregoing description, it will be understood that the operation support device according to the fourth embodiment of the present invention can produce a swing-compensated image to be displayed at a relatively high quality, without being affected by the positional swing and rotational swing of the camera unit 13, by judging whether or not the predictive image produced from the prior images on the basis of the movement of the automotive vehicle 11 is closely similar to the images compensated on the special distance planes 87 on the basis of the positional and rotational swings of the camera unit 13.

As shown in FIG. 18, the operation support device according to the fourth embodiment of the present invention comprises, in place of the judging image synthesizing unit 92 shown in FIG. 15, a judging unit 111, a polygon apex synthesizing unit 112, and a polygon image synthesizing unit 113. The judging unit 111 is operated to judge whether or not each of the swing-compensated images 120 is closely similar to any one of the predictive images corresponding to the respective distance plane 87, and to output the judging result to the polygon image synthesizing unit 112.

The polygon apex synthesizing unit 112 is operated to produce and output, on the basis of the judging results received from the judging unit 111 and polygon-apex data compensated on the special distance plane 87 received from the polygon-apex-coordinates inverse projective transformation unit 89, polygon-apex data compensated on a special distance plane on which the predictive image is closely similar to the swing-compensated image. The polygon image synthesizing unit 113 is then operated to output a swing-compensated image produced from the inputted image 35 on the basis of the polygon-apex data.

As will be seen from the foregoing description, the operation support device according to the fourth embodiment of the present invention can interpolate position data with polygon-apex data without emphasizing local structural discontinuity of synthetic image by reason that the image has a buffer portion 108 shown in FIG. 17(b).

### Fifth Embodiment

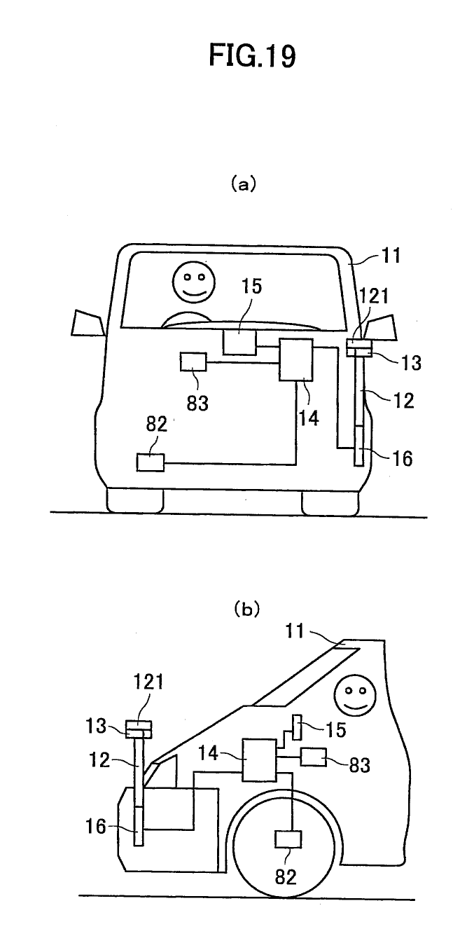

FIGS. 19 to 21 show the fifth embodiment of the operation support device according to the present invention. There will be no description about the detailed construction of the fifth embodiment of the operation support device according to the present invention except for the elements or parts of the fifth embodiment different from those of the first or fourth embodiment but bearing the same reference numbers as those of the first or fourth embodiment.

The operation support device according to the fourth embodiment can output the swing-compensated image 93 with additional obstacle information 110. When the swing of the camera unit 13 is relatively small, the predictive image is almost the same as the image compensated on each of the special distance planes. In this case, the judging image synthesizing unit 92 tends to reduce its accuracy of detecting an obstacle by selecting the road surface 19 even if there is an obstacle in the field angle of the camera unit 13.

On the other hand, the operation support device according to the fifth embodiment is characterized in that oscillation means 121 mounted, as shown in FIG. 19, on the top end of the rod portion 12 to occupy a position the same as that of the camera unit 13. The oscillation means 121 is adapted to swing the camera unit 13 with the rod portion 12, and to output a timing signal.

More specifically, the operation support device according to the fifth embodiment comprises oscillation means 121 for swinging the rod portion 12, and a swing compensation image processing unit 14 (defined as distance detecting means) having inputted therein the image taken by the camera unit 13. As shown in 20, the swing compensation image processing unit 14 includes, in addition to the elements defined in the fourth embodiment, a polygon apex synthesizing unit 112 for selecting the images taken in the vicinity of peaks of the timing signal received from the oscillation means 121, and a switching unit 122 needed to have a polygon image synthesizing unit 113 synthesize swing-compensated image.

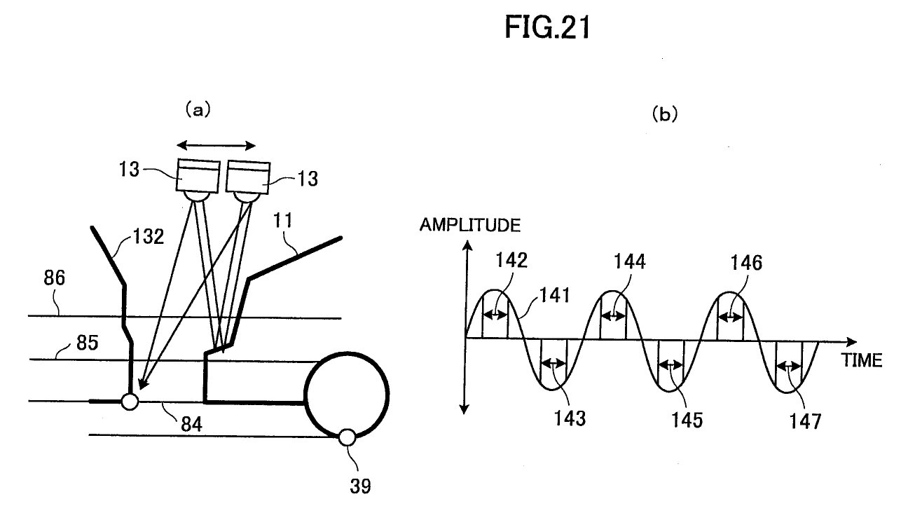

FIG. 21(b) is an explanation showing the swing of the camera unit 13. The camera unit 13 is swung by the oscillation means 121 in response to the timing signal. More specifically, the camera unit 13 is adapted to take images within respective intervals 142 to 147, while the oscillation means 121 is adapted to swing the camera unit 13 with a frequency of 30 cycles per second.

From the foregoing description, it will be understood that the operation support device according to the fifth embodiment of the present invention can detect an obstacle 132 in the field angle of the camera unit 13 while swinging the camera unit 13, by judging whether or not the predictive image corresponds to the swing-compensated image on the special distance plane spaced apart from the road surface 19.

From the foregoing description, it will be understood that the operation support device according to the fifth embodiment of the present invention can detect at a relatively high accuracy whether or not there is an obstacle in the field angle of the camera unit 13 under the condition that the camera unit 13 is being actively swung with the rod portion 12 even if the automotive vehicle 11 is in stopped state.

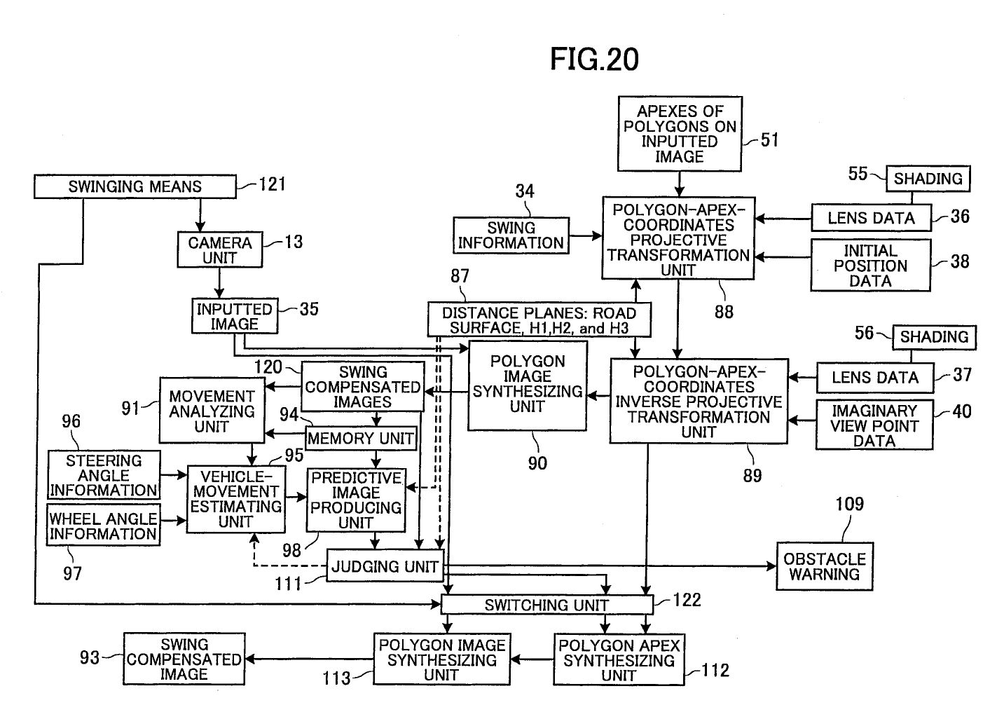

As shown in FIG. 20, the images taken in the vicinity of peaks of the timing signal received from the oscillation means 121 are selected by a switching unit 122 in response to the timing signal received from the oscillation means 121. The swing-compensated image 93 is synthesized by the polygon apex synthesizing unit 112 and the polygon image synthesizing unit 113.

The images taken within intervals 142 to 147 shown in FIG. 21(b) are selected as images taken in the vicinity of peaks of the timing signal. In this case, the swing-compensated images to be outputted as thirty frames moving images per second are synthesized from the images taken within intervals 142 to 147.

From the foregoing description, it will be understood that the operation support device according to the present invention can detect the distance of the special distance plane to the camera unit 13 at a relatively high accuracy by reason that the oscillation means 121 is adapted to swing the camera unit 13 with the rod-like retaining unit 12, and to judge whether the special distance plane is on the road surface 19, or on the obstacle.

Accordingly, the operation support device according to the present invention can output a swing-compensated image 93 to be displayed at a relatively high quality without being affected by the swing of the camera unit 13 by canceling the effect of the swing of the camera unit 13 caused by the oscillation means 121, this swing-compensated image 93 is substantially the same in quality as the image compensated in the fourth embodiment.

### INDUSTRIAL APPLICABILITY OF THE PRESENT INVENTION

As will be seen from the foregoing description, the present invention has an effect of producing an image to be displayed at a relatively high quality without being affected by the swing of the rod-like retaining means. The present invention is available as an operation support device for assisting a driver by taking and displaying an image indicative of one or more objects located around the automotive vehicle.

What is claimed is:

1. An operation support device, comprising:
retaining means in the form of a rod and projected from an automotive vehicle;
image taking means mounted on and retained by said retaining means to take images of objects around said automotive vehicle; and
swing compensation image processing means for processing said images taken by said image taking means with a swing compensation for a swing on a special distance plane distant from said image taking means.

2. An operation support device as set forth in claim 1, in which said swing compensation image processing means is adapted to detect a rotational swing and a positional swing of said image taking means mounted on said retaining means by chasing particular points on said automotive vehicle, and to compensate said image by canceling the effect of said rotational swing and said positional swing of said image taking means on said special distance plane.

3. An operation support device as set forth in claim 1, which further comprises detecting means for detecting a rotational swing and a positional swing of said image taking means, and in which said swing compensation image processing means is adapted to compensate said image by canceling the effect of said rotational swing and said positional swing of said image taking means on said special distance plane.

4. An operation support device as set forth in claim 1, in which said swing compensation image processing means is adapted to perform a projective transformation of said taken image to an image projected on a special distance plane before performing an inverse projective transformation to an image to be outputted as an image taken with no swing by an imaginary image taking means.

5. An operation support device as set forth in any one of claims 1 to 4, which further comprises distance means for detecting a distance between said object and said image taking means, and in which said swing compensation image processing means is adapted to change said special distance plane on the basis of said distance between said object and said image taking means.

6. An operation support device as set forth in claim 1, in which said swing compensation image processing means is adapted to produce images compensated on respective distance planes by canceling the effect of said rotational swing and said positional swing of said image taking means on said distance planes, and to select, as an image to be synthesized, one of said images compensated on said respective distance planes by judging whether or not each of said images compensated on said respective distance planes corresponds to an predictive image which is produced from one or more prior images on the basis of a movement of said automotive vehicle.

7. An operation support device as set forth in claim 1, which further comprises oscillation means for swinging said retaining means, and in which said swing compensation image processing means is adapted to detect said special distance plane with the swing of said image taking means under the condition that said retaining means is being swung by said oscillation means.

8. An operation support device as set forth in claim 1, which further comprises displaying means for displaying said image taken by said image taking means.
